(19) United States
(12) Patent Application Publication
(10) Pub. No.: US 2016/0088714 A1
(43) Pub. Date: Mar. 24, 2016

(54) CONTROLLING A FUNCTION OF A SPACE

(71) Applicant: KONINKLIJKE PHILIPS N.V., Eindhoven (NL)

(72) Inventors: JURGEN MARIO VANGEEL, BEERSE (BE); ROGER PETER ANNA DELNOIJ, LOMMEL (BE); JOHANNES JOZEF WILHELMUS KALFS, EINDHOVEN (NL); MICHEL ALBERTUS THEODORUS KLEIN SWORMINK, EINDHOVEN (NL); PETRUS ANTONIUS VERBEEK, DEURNE (NL); JOHANNES MARTINUS MARIA HENSING, VELDHOVEN (NL)

(21) Appl. No.: 14/888,740

(22) PCT Filed: Apr. 18, 2014
(86) PCT No.: PCT/EP2014/057991

§ 371 Date: Nov. 3, 2015

(30) Foreign Application Priority Data
May 3, 2013 (EP) 13166371.8

(51) Int. Cl. H05B 37/02

(52) U.S. Cl. CPC H05B 37/0227; H05B 37/0281

(57) ABSTRACT

A controller for use with a sensing apparatus that comprises a receiver for receiving echoes of an emitted signal. The controller comprises a control module for sensing a being in a space based on the echoes, configured to provide a function of the space in dependence on the sensing; and a timer configured to prevent a change in state of the function for a period after a result of the sensing. The control module is further configured to dynamically measure an estimate of disturbance received by the receiver and adapt the period based on the estimated disturbance.

### TECHNICAL FIELD

The present disclosure relates to the sensing of a being within a space, and to providing a function of that space in dependence on the sensing. For example the sensing may be used to control one or more lighting devices in dependence on a detected occupancy within a room, corridor, or other indoor or outdoor space; or for other sensing applications.

### BACKGROUND

Lighting systems typically include presence detectors that detect whether or not any persons are present in certain areas. Presence detectors can help reduce energy consumption by switching off light sources in areas where no presence is detected.

Typically, a presence detection system for an illumination system will incorporate a ‘grace period’ timer. Each time the presence detection system detects presence (e.g. detects movement of an occupant in an office), it resets the grace period timer. When the timer expires, this indicates that no presence has been detected during the grace period, and the lights of the illumination system are switched off.

### SUMMARY

According to one aspect disclosure herein, there is provided a controller for use with a receiver for receiving echoes of an emitted signal. The controller comprises a control module for sensing a being in a space based on said echoes, configured to provide a function of the space in dependence on the sensing; and a timer configured to prevent a change in state of the function for a period after a result of said sensing. The control module is further configured to dynamically measure an estimate of disturbance received by the receiver and adapt said period based on the estimated disturbance.

For instance, the controller may be used in a lighting system comprising the receiver arranged to receive the echoes of the emitted signal, a transmitter arranged to emit the signal, and one or more lighting devices arranged to illuminate the space. In this case the function comprises operating the one or more lighting devices to provide light upon sensing a being in the space, and the prevention of the change in state comprises preventing the one more lighting devices being dimmed down or turned off for said period.

According to a further aspect, there may be provided a computer program product for performing sensing based on echoes of an emitted signal. The computer program product comprises code embodied on a computer-readable medium and being configured so as when executed on a processor to perform operations on accordance with any of the sensor features disclosure herein.

### BRIEF DESCRIPTION OF THE DRAWINGS

For a better understanding of the present disclosure and to show how embodiments may be put into effect, reference is made to the accompanying drawings in which:

FIG. 1 is a schematic illustration of a sensing region within a space,

FIG. 2 schematically illustrates a series of timeslots,

FIG. 3 is a schematic block diagram of a lighting device with sensor,

FIG. 4 is a schematic block diagram of a lighting device with distributed sensor system,

FIG. 5 is a sketch schematically illustrating a sensor signal with noise,

FIG. 6 is another sketch schematically illustrating a sensor signal with noise, and

FIG. 7 is a schematic flow chart of a sensing method.

### DETAILED DESCRIPTION OF PREFERRED EMBODIMENTS

The following embodiments relate to presence detection using an active sensor such as ultrasonic sensor, which may be used to control the lighting in a space such as an office or other room. As mentioned, typically this kind of presence detection system will also incorporate a ‘grace period’ timer to prevent the light being turned off unless no presence is detected for the duration of grace period. This way the user is spared the annoyance of the lights turning off too readily when he or she is present but relatively still, e.g. sitting working at a desk.

The performance of a presence detector may be judged by a number of criteria, including sensitivity to movement and absence of so-called false triggers. There is a delicate balance to be found between these two criteria. When systems are more sensitive they are generally also more likely to generate false triggers. The shorter the grace period, the more energy can be saved (e.g. when an occupant leaves an office, the lights in the office will be switched off sooner, so more energy will be saved). On the other hand, the shorter the grace period, the more likely it is that the lights of the illumination system will be switched off when they should remain on (e.g. when an occupant remains present in an office, but is quite motionless for a period of time). The latter case may be called a “false-off”.

One way to mitigate the false-off problem is to increase the sensitivity of the sensors of the presence detection system. In the above example, if the sensor sensitivity were set as high as possible (and if there were no background noise), the occupant would have to remain almost completely motionless to avoid resetting the grace period timer, so false-offs should be very rare. However, in practice there will always be some background noise, so some small movements of the occupant will be difficult (perhaps impossible) to distinguish from the background noise. The obvious solution is to set sensor sensitivity based on worst case background noise, and to increase the grace period until there are few or no false-offs (which can be determined straightforwardly). Thus static system settings are set to try to balance energy saving against occupant comfort (i.e. by minimizing false-offs).

For instance, noise levels may depend on the environment (i.e. for ultrasound sensors, airflow is known to be a source for higher noise). The noise levels will determine what the sensitivity of the sensor will be: the higher the noise levels, the less sensitive the sensor is set. As it's not known beforehand in which environment a sensor will be mounted, the straightforward solution would be to equip the sensors with a timer large enough to avoid false offs in the worst case scenarios.

However, this means that in most cases there would be untapped potential energy savings.

Therefore, rather than just setting the grace period for the lowest sensitivity and the worst case noise scenario, the present invention instead provides a controller configured to dynamically vary the grace period in dependence on variations in an estimated background noise level. For example the estimated background noise level may be obtained by averaging the sensor output(s). Thus there is provided a technique to determine an optimum time duration given the measured noise level, in order to improve energy savings.

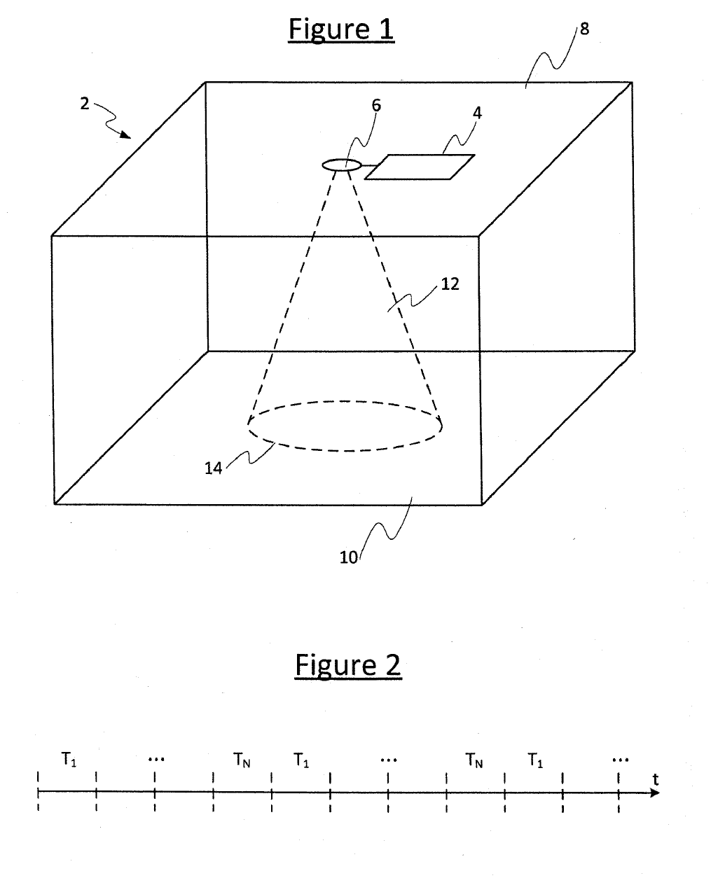

FIG. 1 illustrates an example of an environment comprising a lighting system in which embodiments disclosed herein may be employed.

The environment comprises an indoor or outdoor space 2 such as an office space, an interior space within a home, a laboratory, a marquee, garden or park, etc. The space 2 comprises a sensor 6 mounted or otherwise disposed at a location enabling it to sense a being in the space 2 or a desired region 12 within the space. In the illustrative example, the sensor 6 is mounted on the ceiling 8 of the office 2 so as to sense presence of someone walking on the floor 10. In this case the sensing region 12 may correspond to a certain area 14 on the floor 10.

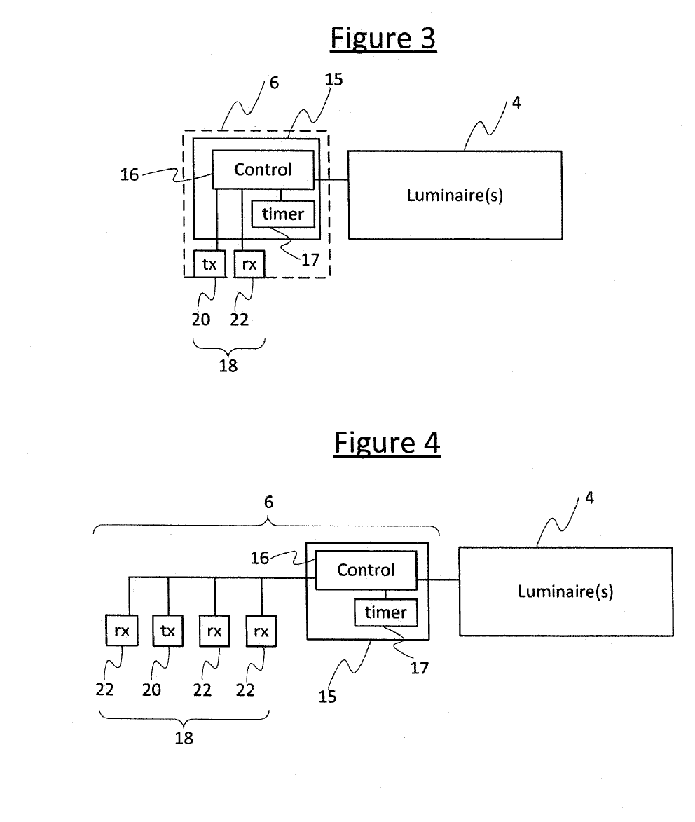

As shown schematically in FIG. 3, the sensor 6 comprises controller 15, and an ultrasound transceiver 18 comprising an ultrasound transmitter 20 and an ultrasound receiver 22 coupled to the controller 15. The controller 15 may be implemented in code (software) stored on a memory comprising one or more storage media, and arranged for execution on a processor comprising on or more processing units. The code is configured so as when fetched from the memory and executed on the processor to perform operations in line with embodiments discussed below. Alternatively it is not excluded that some or of the functionality is implemented in dedicated hardware circuitry, or configurable hardware circuitry like an FPGA.

In an example application of the teachings disclosed herein, the space 2 comprises one or more lighting devices 4 in the form of one or more luminaires operable to emit light. The controller 15 of the sensor 6 is coupled to the luminaire(s) 4 for controlling the light to be turned on or off, or dimmed, in dependence on presence being sensed. The luminaire(s) 4 may be arranged to be controlled directly by the sensing results output by the controller 15, or by the controller 15 reporting sensing results to a separate control unit, e.g. a central controller responsible for controlling a plurality of luminaires.

In embodiments the controller 15, transmitter 20 and receiver 22 are integrated together into the same unit (e.g. same housing) to form a self-contained sensor unit. For example the controller 15 may take the form of code stored on an embedded memory of the sensor 6 and arranged for execution on an embedded processor of the sensor 6. Further, in some embodiments the sensor 6 may be integrated together into the same unit (same housing) as a luminaire 4, to form a self-contained, autonomously controlled lighting unit.

In alternative arrangements as illustrated in FIG. 4, the transceiver 18 need not be self-contained and/or need not comprise the same number of transmitters 20 as receivers 22. Instead there may be provided a plurality of receivers 22 distributed about the space 2 and served by a common transmitter 20. Alternatively or additionally, the controller 16 (or some elements of it) could be remote from the transmitter 20 and/or receiver(s) 22, e.g. as part of a central controller processing signals from multiple receivers. In general any combination of integrated or distributed components is possible.

The transmitter 20 is arranged to emit an ultrasound signal. In embodiments the signal is emitted in the form of a series of pulses of a certain frequency (e.g. 40 kHz), but it could also be a continuous wave identifiable by its frequency (e.g. again 40 kHz). The transceiver 18 also comprises a receiver 22 for receiving back echoes of the transmitted signal, e.g. of the transmitted pulses. Presence can be sensed based on detection of the pulses (or more generally signal) being echoed (reflected) from a being, e.g. by detecting motion based on a Doppler shift between the transmitted signal and received echo. Techniques for sensing of presence based on reflected echoes will in themselves be familiar to a person skilled in the art.

FIG. 2 illustrates a scheme for emitting pulses and detecting echoes of those pulses in order to perform sensing. Here, the sensor 6 is arranged to operate according to a time slot based scheme, whereby the sensor 6 is allocated a certain time slot T₁ of the scheme, in which it performs its sensing. The time slot T₁ occurs at repeated instances over time, e.g. regularly in time. In embodiments there is also a space between the successive instances of a given time slot T₁, e.g. the instances of the time slot T₁ occurring at regular intervals. For example, the scheme may comprise a sequence of multiple exclusive, successive time slots T₁ . . . T_{N} and the sensor 6 may be one of multiple sensors operating in the same environment, with each being configured to use a different respective one of the time slots T₁ . . . T_{N}. In this case the sequence repeats over time, with each sensor using an instance of its respective time slot in each repeated instance of the cycle.

The controller 15 of the sensor 6 comprises a control module 16 and a timer 17. The control module 16 is arranged to process the incoming signals arriving at the receiver 22 in order to detect whether a being appears to be in the space 2. For example this may be done based on motion if motion is detected it is assumed this is due to a living thing, most likely person in a typical application. The control module 16 thus generates a signal whose magnitude represents the output of the receiver 22, which is indicative of presence, e.g. representative of an amount of motion sensed. For instance the magnitude of the signal may be represented in terms of amplitude or power (amplitude squared).

The transmitter 20 emits a pulse at the beginning of one instance of its time slot T₁ and listens for any echo occurring in the rest of that instance of the time slot T₁. If the magnitude of the signal received at the receiver 22 exceeds a detection threshold, the control module 16 determines this to be a positive sensing result indicative that a being is found in the space 2 (of course the control module 15 cannot necessarily know that the thing being sensed is alive, but it is assumed the property being sensed, e.g. motion, is likely to be due to a living being). Beyond the end of the instance of the respective time slot T₁ on the other hand, the control module 16 does not consider received signals to be indicative of presence and need not process those signals, e.g. because it is now the time T₂ . . . T_{N} in which pulses from other sensors will be emitted, and/or because that would represent a time-of-flight and therefore distance from the sensor that is beyond the range of interest.

The control module 16 is arranged to control the one or more luminaires 4 to be switched on and off, and/or dimmed, in dependence on whether a positive sensing result is determined to occur given the incoming signals arriving at receiver 22 in instances of the respective time slot T₁. The control module 16 is also configured to consult the timer 17 in order to determine whether the lack of a positive sensing result will cause the lighting device(s) 4 to be turned off (or perhaps dimmed). Each time the control unit 16 determines a positive sensing result, then at that time it resets the timer 17 and the timer 17 begins counting out a period which may be referred to herein as a grace period. If the control module 16 determines another positive sensing result to occur before the grace period has expired (starting from the most recent reset), it resets the timer 17 again so that it goes back to counting out the grace period again from the beginning I e the timer value is reset to its starting value. If on the other hand the control does not find any positive sensing result to have occurred before the grace period has expired (starting from the most recent reset)—that is, before the timer 17 counts out the whole grace period, i.e. before the timer value reaches its expiry value—then the control module 16 switches off the one or more luminaires 4 (or alternatively dims them down).

When using sensors such as pulse-based ultrasound presence sensors, presence (e.g. motions) that are detected result in a signal of a certain amplitude. For example the amplitude of this signal can be related to the size/speed of the movement. A person walking (and therefore making larger movements) will give a larger signal than a person typing behind a computer. No presence results in a much lower amplitude signal.

However, the received signal will also comprises a certain amount of disturbance. The term disturbance is used herein to refer to any of random or meaningless noise, and/or any interference from another signal source such as active another sensor in the same environment, or to any other unwanted disturbances (other than the wanted signal) that are not necessarily readily categorized as either completely random or due to another signal. For example the jangling of a set of keys can create high frequency tones which interfere with an ultrasound sensor. In another example the noise level will also be impacted by disturbances in the environment (i.e. airflow): more airflow will give an increased noise level. E.g. this could result from air conditioning. In the following the term noise may be used, but it will be understood this does not limit to purely random noise and the teachings may be relevant to dealing with any kind of disturbance in a received signal.

The control module 16 is configured to automatically adjust the detection threshold depending on the noise floor. So with low noise levels the threshold will be lower (higher sensitivity), and the sensor 6 and will be capable of detecting smaller motions. On the other hand if noise levels are higher than the detection threshold will be higher (lower sensitivity), and the sensor 6 will only be sensitive to greater motions.

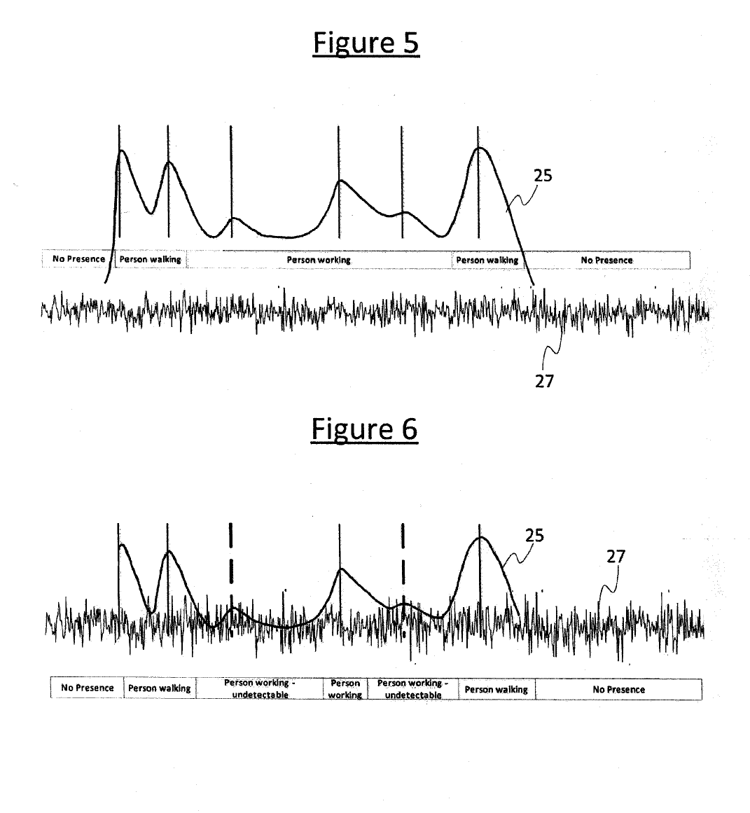

Referring to FIGS. 5 and 6, when noise levels are increased, lower amplitude signals caused by minute movement will be more difficult or impossible to detect, resulting in a lower sensitivity.

FIG. 5 shows an example of signal levels in relatively low noise conditions. Here the wanted component 25 of an ultrasonic sensor signal from the output receiver 22 is shown overlaid with a negligible noise component 27. Each peak of the sensor signal (marked with solid lines) is distinguishable from the noise. The wanted signal's amplitude is significantly higher than the observed noise levels in a no presence state, so the control module 16 can lower its detection threshold (the threshold above which the signal magnitude is taken as a positive result), making it more sensitive so that it can detect presence relatively easily, and furthermore potentially distinguish different movements.

FIG. 6 on the other hand shows an example of signal levels under conditions of relatively high noise. Here the wanted component 25 of the ultrasonic sensor signal 25 is competing with increased noise 27. In this example two of the peaks (marked with dashed lines) of the sensor signal are indistinguishable from the noise. The control module 15 has to raise its detection threshold to avoid noise triggering false detection results, which means some genuine presence results (e.g. small motions) will be missed. For example noise levels may be increased due to airflow (e.g. air conditioning switched on in the room), and as a result minor motions when a person is working may no longer be detected.

This means that for situations where noise levels are increased, a presence detector can only base its decisions on larger motions (as they will be the only signals still above threshold) which occur less frequently than minor motions. Accordingly, the presence timer 17 has to be set with a large enough grace period in order for the sensor 6 to operate reasonably reliably.

According to embodiments disclosed herein, rather than preconfiguring the grace period to a fixed value designed for the worst case scenario, the control module 16 is configured to dynamically adapt the grace period in dependence on the noise actually observed at the relevant time. That is to say, the noise level is automatically measured “in the field” or at runtime under actual operating conditions, and based on this the grace period is automatically adapted “on the fly” during ongoing operation of the controller when controlling the lighting. In the case where the sensing is performed in repeated instances of a time slot T₁, the measurement and adaptation are therefore performed automatically by the control unit 6 over a time spanning a plurality of instances of the time slot, e.g. during each of the plurality of instances of the time slot. Further, the measurement and adaptation are performed automatically by the control module 16 after any initial commissioning or calibration of the system, i.e. during ongoing use of the system by the end user.

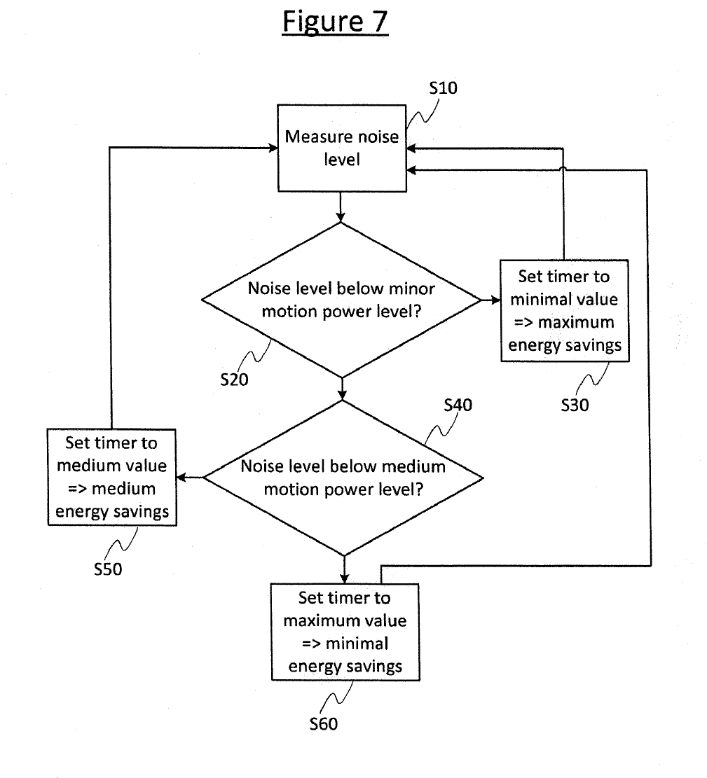

FIG. 7 gives a flow chart illustrating an example of the method that may be implemented in the control module 16.

At step S10 the control module 16 measures an estimate of the noise in the signal received at the receiver 22. In embodiments the measurement may be performed by measuring the received signal level in one or more instances of the sensor's time slot, preferably just in those instances when no positive sensing result is determined to occur (going by the current detection threshold). For example the control module 16 may measure an average of the signal level over one or more instances of the time slot, e.g. the mean signal level or some other indication of overall or representative signal level in these instances. In embodiments, it may measure an average during each instance of the time slot T₁ individually and determine how to adapt the grace period each time. Alternatively it may maintain running average over a plurality of instances of the time slot Ti going back in time, and determine how to adapt the grace period after each of a plurality of updates to the running average.

In alternative embodiments, other ways of measuring noise could be used. For example, the control module 16 may measure the received signal level in between the instances of the sensor's respective time slot T₁. Alternatively or additionally, the control module 16 may measure the signal level in the same time slot and even at the same time as a positive sensing result is detected, but in a region of the frequency spectrum outside the expected frequency band of the echo (which will may a predetermined waveform and therefore spectral density). For example the signal level may be measured in a region either side of the echo's expected band, close by but not within it. This may be taken as indicative of what the noise within the band is likely to be like.

For the present purposes, it may be preferred to use the technique of measuring in the same time slot, in band, and only when no detection result is found (i.e. when the signal does not exceed the current detecting threshold). However, generally any technique or combination of techniques for measuring noise may be used. Further, the measurement of noise used to adapt the grace period does not necessarily have to measurement used to adjust the detection threshold (i.e. sensitivity) if the sensor 6, though in embodiments it may be.

At step S20, the control module 16 determines whether the current noise level is below a first, minor motion power level threshold (or more generally magnitude threshold). If so, at step S30 it sets the grace period of the presence timer 17 to a first predetermined value that is relatively short. Due to the low noise, the control unit 16 will also have adjusted the sensitivity of the sensor to a greater level (reduced the detection threshold). The system will now react quickly to ‘no presence’, so lights will be switched off fast, implying higher energy savings on average. The method then returns to step S10 where the control module 16 continues measuring power and performing further determinations as to the adaptation of the grace period.

If the current noise level did not fall below the first, minor threshold on the other hand, the method proceeds to step S40 where the control module 16 determines whether the current noise level is only below a second, medium motion power level threshold. If so, at step S50 it sets the grace period of the presence timer 17 to a second, intermediate predetermined value. Due to the medium amount of noise, the control unit 16 will also have adjusted the sensitivity of the sensor to a somewhat lesser level (increased the detection threshold). The system will now react less quickly to ‘no presence’, so lights will be switched off less fast, implying medium energy savings. The method then returns to step S10 where the control module 16 continues measuring power and performing further determinations as to the adaptation of the grace period.

If however the current noise level did even not fall below the second, intermediate threshold—i.e. noise levels are at large motion power levels—the method proceeds to step S60 where the control module 16 sets the grace period of the presence timer 17 to a third predetermined value that is large compared to the first and second values. Due to the high amount of noise, the control unit 16 will also have adjusted the sensitivity of the sensor to an even lower level (increased the detection threshold to an even higher level). The system will now react slowly to ‘no presence’, so lights will be switched off after only slowly implying reduced energy savings. The method then returns to step S10 where the control module 16 continues measuring power and performing further determinations as to the adaptation of the grace period.

This method can be used to enable higher energy savings while still maintaining robustness to false offs.

In another embodiment there may be implemented a direct relationship (calculation via a formula) between noise levels and timer setting to try to achieve a more optimal setting at all times. That is to say, the control module 16 may be configured according to a relationship between noise and grace period that, substantially, is continuously variable (i.e. within the constraints of a digital representation). This avoids a staggered approach and in embodiments may allow for more optimal power savings. For example the control module 16 may implement a direct linear relationship between noise levels and timer setting.

It will be appreciated the above embodiments have been described only by way of example.

For instance, sensing presence is not limited to sensing motion, nor sensing a human. Generally presence sensing techniques are available for sensing either the motion or the existence of any being (whether human or other living creature). Further, the teachings above to not have to be limited to ultrasound sensing, but could be extended to any active sensing technique based on the emission of any signal (e.g. mechanical or electromagnetic radiation) and receiving back echoes of such a signal. Where the sensor is an ultrasound sensor, the receiver 22 may or may not be dedicated to receiving just ultrasound. In embodiments, besides measuring the ultrasonic content, these microphones can also be used for receiving audible sound.

Further, the techniques disclosed herein could be extended to other ways of controlling the light provided into a space, such as a heliostat or window treatment (e.g. automatic blinds); or indeed other functions of a space provided to the being or for the benefit of the being expected in the space, such as air conditioning or heating. Where the function is light, this is not limited to being switched on and off in a yes/no fashion, but the idea could also extend to adapting the time before which the light is dimmed. Similarly where some other function is in question, the grace period may determine the period before which the function is either deactivated or powered down to some lower power state of operation. Generally the grace period may be the period before which any change in state of some functionality of the space occurs. Further, the change of state need not necessarily refer to a moment at which the state suddenly occurs. For example the grace period could comprise a period over which the lights gradually dim down to a lower level, in which case the change in state may refer to the point at the expiry of the grace period when the light reaches the lowest level in this dimming process (e.g. reaches the off state or a lower steady state level).

In embodiments the control module 16 is configured to adjust the sensitivity of the sensor as well as the grace period, increasing sensitivity as noise decreases. However, in other applications the sensor could have a fixed sensitivity. For example consider a sensor of fixed sensitivity which turns on a light or other function on condition that it continues to detect presence for a certain period (say a second or two). The issue may then be to avoid a false on. With a fixed sensitivity more noise will mean more false sensing results, so it may be desirable to prolong the period for which a positive sensing result must continue to be (apparently) detected before turning the lights or other function on (i.e. the period for which the signal must remain above the detection threshold to trigger the function).

Where it is said above that a value is within a limit or threshold (or the like), this covers the options of either a “less than” type operation or a “less than or equal” to type operation. Similarly, where it is said that a value is beyond or exceeds a limit or threshold (or the like), this covers the options of either a “more than” or a “more than or equal to” type operation.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A controller for use with a receiver for receiving echoes of an emitted signal, the controller comprising:
a control module for sensing a being in a space based on said echoes, configured to provide a function of the space in dependence on the sensing; and
a timer configured to prevent a change in state of the function for a period after a result of said sensing;
wherein the control module is further configured to dynamically measure an estimate of disturbance received by the receiver and adapt said period based on the estimated disturbance.

2. The controller of claim 1, wherein said prevention of the change in state comprises preventing the function being powered down or deactivated.

3. The controller of claim 1, wherein said result comprises sensing a being in the space.

4. The controller of claim 1, wherein the sensing comprises sensing motion.

5. The controller of claim 1, wherein the function comprises providing light in the space, said prevention of the change in state comprises preventing the light being dimmed down or turned off for said period.

6. The controller of claim 1, wherein the control moduleis configured to measure the estimate of disturbance by determining an average output of the receiver over time.

7. The controller of claim 1, wherein:
the signal comprises a series of pulses each emitted in a respective instance of a time slot; and
the control module is configured to perform said sensing by listening for an echo in each of the instances of the time slot, and to measure said estimate of disturbance over a plurality of the time slots.

8. The controller of claim 7, wherein the control module is configured to measure the estimate of disturbance by determining an average output of the receiver over the plurality of time slots.

9. The controller of claim 1, wherein the control module is also configured to adjust a sensitivity of the sensing in dependence on an estimate of the disturbance.

10. The controller of claim 1, wherein the control module is configured to compare the estimate of disturbance to at least a first threshold, to set said period to a first value if the estimate is within the first threshold, and to the period to a second value if the estimate is beyond the first threshold, the second value being longer than the first value.

11. The controller of claim 10, wherein the control module is configured to compare the estimate of disturbance to the first threshold and at least a second threshold higher than the first threshold, to set said period to the second value if the estimate is beyond the first threshold but within the second thresholds, and to set the period to a third value if the estimate is beyond the second threshold, the third value being longer than the second value.

12. The controller of claim 1, wherein the control module is configured to adjust said period substantially according to a continuously variable relationship between the period and the estimate of disturbance.

13. The controller of claim 12, wherein said relationship is a linear relationship.

14. A lighting system comprising:
the controller according to claim 1;
the receiver arranged to receive the echoes of the emitted signal;
a transmitter arranged to emit said signal;
one or more lighting devices arranged to illuminate the space;
wherein said function comprises operating the one or more lighting devices to provide light upon sensing a being in the space, and said prevention of the change in state comprises preventing the lighting devices being dimmed down or turned off for said period.

15. Computer program product for performing sensing based on echoes of an emitted signal, the computer program product comprising code embodied on a computer-readable medium and being configured so as when executed on a processor to perform operations of:
sensing a being in a space based on said echoes,
providing a function of the space in dependence on the sensing,
preventing a change in state of the function for a period after a result of said sensing, and
dynamically measuring an estimate of disturbance received by the receiver and adapting said period based on the estimated disturbance.
